(19) United States
(12) Patent Application Publication
(10) Pub. No.: US 2026/0235358 A1
(43) Pub. Date: Aug. 13, 2026

(54) FREEZE-DRYING APPARATUS

(71) Applicant: GEA Process Engineering A/S, Søborg (DK)

(72) Inventors: Sikker Rosendal, Søborg (DK); Michael Krebs, Søborg (DK); Jens Dahl Kunoy, Søborg (DK)

(73) Assignee: GEA Process Engineering A/S, Søborg (DK)

(21) Appl. No.: 19/104,826

(22) PCT Filed: Aug. 31, 2023
(86) PCT No.: PCT/EP2023/073909

§ 371 Date: Feb. 19, 2025

(30) Foreign Application Priority Data
Sep. 2, 2022 (EP) 22193731.1

(51) Int. Cl. F26B 5/06; F26B 5/04; F26B 25/12

(52) U.S. Cl. CPC F26B 5/06; F26B 5/044; F26B 25/12

(57) ABSTRACT

The present invention relates to a freeze-drying apparatus having a drying chamber and condenser chambers positioned laterally to the drying chamber and separated therefrom by side walls, wherein openings in the side walls are positioned within a stack height of a heating arrangement positioned in the drying chamber.

### FIELD OF THE INVENTION

The present invention relates to a freeze-drying apparatus and a method for operating a freeze-drying apparatus. In particular it relates to a freeze-drying apparatus comprising a drying chamber extending from a first end to a second end of the drying chamber along a longitudinal axis L, from a bottom to a top of the drying chamber along a height axis H, and from a first side to a second side of the drying chamber along a lateral axis W, a central horizontal plane CP of the drying chamber extending in parallel to the longitudinal and lateral axes and being positioned centrally in the drying chamber in relation to the height axis, a door at the first end of the drying chamber, a first condenser chamber containing a first condenser arranged laterally to the drying chamber at the first side with a first wall between the first condenser chamber and the drying chamber, a second condenser chamber containing a second condenser arranged laterally to the drying chamber at the second side with a second wall between the second condenser chamber and the drying chamber, each of which first and second walls is provided with at least one opening allowing fluid communication between the drying chamber and the respective condenser chamber, and a heating arrangement comprising a plurality of heating elements which heating elements are spaced apart in the height axis, with a stack height extending between a bottom heating element and a top heating element.

### BACKGROUND

Freeze-drying is a process for drying a product by freezing the product to a temperature below the triple point of water and reducing the pressure to sublimate ice. A typical application of freeze-drying is to dry food, nutraceutical or pharmaceutical products where water is the liquid to be removed, but freeze-drying can also be used for other products and to remove other liquids.

On a general level freeze-drying involves four steps: Freezing the product, loading the frozen product onto suitable trays (or vice versa) and into a freeze-dryer, typically on a trolley carrying the trays, drying the product at reduced pressure in the freeze-dyer, and unloading the dried product. The drying process in the freeze-dryer involves evacuating the drying chamber by a vacuum pump to below the triple-point and supplying heat for the phase transition (heat of sublimation). To handle the vapor generated in the drying chamber, condensers (steam traps) are arranged between the vacuum pump and drying chamber, to condense/deposit the vapor by cooling. The condenser has a critical role in the freeze-drying process regarding the capacity and represents a significant portion of the operational cost due to cooling/refrigeration duty. The condenser should condense substantially all the vapor and prevent it from entering the vacuum pump. At the same time, the condenser and its associated components should allow for efficient removal of vapor from the drying chamber to prevent pressure build-up in the drying chamber, i.e., it should not impose too large a pressure drop. An even distribution of ice growth on the condenser is also advantageous. Thick ice layers increase thermal resistance, which then requires colder refrigerant temperatures to reach sufficiently low temperatures at the ice surfaces. At the same time, thick ice layers restrict flow potentially causing an increased drying chamber pressure, and may increase local gas velocity causing lower local pressures, which again lowers the temperature required to the condense the vapor. In addition to these condenser design objectives, it is also desirable that the freeze-dryer is easy to clean, as the freeze-dryers are often used for food products or other products with hygienic or sanitary requirements.

U.S. Pat. No. 3,543,411 discloses a freeze-dryer with condensers arranged inside the drying chamber, with condenser tubes arranged for uniform tube temperature and uniform ice growth. This design may offer limited flow resistance, but the condenser must be sized to condense all vapor during the entire drying process as the condenser cannot be de-iced during the drying process. This may entail large condensers or significant ice-build-up which may increase refrigeration costs and result in varying condenser capacity during the drying process.

This is addressed by using freeze-dryers with multiple condensers each of which can be isolated from the drying chamber for de-icing. During the drying cycle the condensers can be sequentially isolated and de-iced, providing substantially constant condenser capacity and reducing refrigeration costs by preventing excessive temperature drops across the ice-layer.

One such system is GEA Ray™ for batch freeze-drying with condensers arranged side by side at the bottom of the drying chamber. U.S. Pat. No. 3,401,466 also discloses another freeze-dryer having multiple condensers in separate condenser chambers separated from the drying chamber by walls, which may provide substantially constant condenser capacity and reduce ice-layer temperature drops by allowing de-icing, but the design also impedes vapor flow which leads to unnecessary pressure drop, increases drying chamber pressure and may generate excessive gas velocities causing less uniform ice-layer thicknesses.

### SUMMARY OF THE INVENTION

On this background, it is an object of the invention to provide a freeze-drying apparatus with improved fluid flow properties. Further objects may be to reduce operational cost, e.g., refrigeration duty, reduce vacuum pump size, increase product capacity by volume, a simplified freeze-dryer construction and/or improving cleanability.

These and further objects are achieved by a freeze-drying apparatus according to the invention which is furthermore characterized in that at least one of the openings in each of the first and second wall extends at least partially within the stack height. The least one opening extending at least partly within the stack height is understood such that if the stack height and a height of the opening is projected onto the height axis, there will be at least a partial overlap between the two projections. Arranging the opening within the stack height may improve the fluid flow properties of the freeze-drying apparatus, providing a reduced drying chamber pressure. It may for example, provide a reduced pressure drop from drying chamber to condenser chamber and/or provide more uniform pressure distribution in the drying chamber and/or condenser chamber. This may in turn reduce refrigeration duty. Improving fluid flow properties of the freeze-drying apparatus may also allow for reducing vacuum pump size. When in operation, trays carrying the product to be dried are positioned in between the heating elements, and in some cases on the heating elements. Hence, the stack height is substantially equivalent to a height extent of the trays when these are positioned in the drying chamber. Without being bound by theory, having the opening be level with the heating arrangement in this way, and thus with the trays carrying product, may create a less restricted flow path. Arranging the condensers, side walls and openings according to the invention, may also allow for a larger portion of the drying chamber to be used for trays, increasing production capacity per unit volume of the freeze-drying apparatus, and the improved fluid flow properties of the freeze-drying apparatus may efficiently handle the increase vapor volume generated per unit volume when increasing the capacity.

In an operational condition of the freeze-drying apparatus, one or more trolleys is positioned in the drying chamber. The trolley(s) is/are configured to support a plurality of trays in a horizontal position in which the trays extend substantially in parallel to the central horizontal plane CP of the drying chamber. When the trolley is in the drying chamber, the trays are arranged in between the heating elements of the heating arrangement, typically in contact with the heating elements. The trolley is typically fastened to a rail arrangement provided in the drying chamber, which allows the trolley to move in and out of the drying chamber. The trolley may comprise a plurality of support elements for supporting the trays in the horizontal position. The trolley has a trolley height extending between a bottom of the trolley and top of the trolley. The bottom of the trolley arrangement may be a bottom support element of the trolley arrangement and the top of the trolley arrangement may be a top support element. Hence, the height extent of the trays may be substantially between the bottom support element and the top support element. The bottom support element is the support element proximal to the bottom of the drying chamber, and the top support element is the support element proximal to the top of the drying chamber. Hence, the stack height HS (of the heating arrangement) and the trolley height each correspond substantially to the height extent of the trays. The stack height HS is presently considered a suitable reference for the position of the least one opening in each of the first and second side walls. However, in additional or alternative definitions of the invention, the at least one opening in each of the first and second wall extends at least partially within the trolley height and/or within the height extent of the trays. The height extent of the trays is the distance between along the height axis along a bottom tray, proximal to the bottom of the drying chamber, and a top tray, proximal to the top of the drying chamber, and refers to an operational condition wherein the number trays correspond to the number which can be accommodated by the heating arrangement, i.e., the number of trays for which the freeze-drying is sized.

In the following, and unless otherwise specified, features described for a “condenser chamber” apply to both the first and second condenser chamber, as the freeze-drying apparatus is preferably symmetrical in this regard. Similarly, features of a “side wall” apply both the first and second side wall unless otherwise noted. The same applies to features pertaining to a “condenser” or an “opening”. The freeze-drying apparatus is described with reference to the longitudinal axis, the lateral axis, and the height axis, which refer to the orientation of the freeze-drying apparatus when in operation, i.e., with the height axis being parallel to gravity. The length, width, and height dimensions of elements of the freeze-drying apparatus as used herein refers to the dimensions as measured along the longitudinal, lateral and height axes respectively.

In some embodiments, said least one opening in each of the first and second wall extends fully within the stack height HS.

In some embodiments, a first of the openings in the respective side walls extends above the central horizontal plane of the drying chamber, and a second of the openings in the respective side walls extends below the central horizontal plane. In this way, the vapor will have at least two points of entry into the respective condenser chambers, allowing vapor originating from trays above and below the central horizontal plane to flow towards the first and second opening respectively. This may reduce drying chamber pressure and/or increase uniformity of pressure in the drying chamber and/or condenser chambers, providing more uniform drying conditions for the product across the drying chamber and more uniform condensing conditions across the condenser chamber, and/or more efficiently utilize a surface area of the condenser. By the first opening extending above the central horizontal plane is understood that if a height of the first opening is projected onto the height axis, at least part of the projection and possibly all of the projection will be above a projection of the central horizontal plane on the height axis. Correspondingly, by the second opening extending below the central horizontal plane is understood that if a height of the second opening is projected onto the height axis, at least part of the projection and possibly all of the projection will be below the projection of the central horizontal plane on the height axis.

Additionally, or alternatively, the first of the openings in the respective side walls extends above a central horizontal heating arrangement plane of the drying chamber, and the second of the openings in the respective side walls extends below the central horizontal heating arrangement plane. The central horizontal heating arrangement plane extends in parallel to the longitudinal and lateral axes and is positioned centrally in relation to the stack height HS.

The first opening and second opening may have the same dimensions, i.e. same length and height. They will typically have the same longitudinal position.

Typically, openings are provided in the side walls along substantially the entire length of the drying chamber, the length of the drying chamber extending from the first end to the second of the drying chamber. The openings will typically have the same dimensions.

In some embodiments, the first opening is provided at least partly above the respective condensers and the second opening is provided at least partly below the respective condensers. This may further improve the flow properties of the freeze-dryer, e.g. reducing pressure drop and/or increasing pressure uniformity. In a further development, the first and second opening extend fully above and fully be-low the respective condensers. By an opening being provided at least partly above a condenser it is understood that if a height of the opening and a height of the condenser is projected onto the height axis, there will be at least a portion of the opening projection which is above the projection of the condenser. Correspondingly, by “fully extending” above the condenser projection, the opening projection is fully above the condenser projection. Hence, the first opening may be positioned laterally to and above the respective condenser, and the second opening may be positioned laterally to and below the respective condensers. Positioning the openings above and below the condenser, respectively, also allows for using closing mechanisms (valves) which move into the condenser chambers when opening, as will be described in greater detail below.

In some embodiments, the first and/or second opening extend at least partially within the stack height HS. Hence, said at least one opening which extends at least partially within the stack height HS may be the first opening and/or the second opening. Similarly, the first and/or second opening may extend at least partially with the trolley height and/or the height extent of the trays.

In some embodiments, the first and second openings extend partly with the stack height HS and partly above and below the stack height HS respectively. This may further improve fluid flow properties, by providing both an open flow path for the vapor flowing from the trays laterally toward the opening and for the vapor which flows around (above and below) the heating arrangement, which may be a significant portion of the vapor, especially when the opposite condenser is de-icing.

In some embodiments, respective intermediate portions of the first and second walls extending between the respective first and second, are solid. By the intermediate portions being solid is understood that no openings between condenser chamber and drying chamber are provided, i.e. the intermediate portion is uninterrupted. Having solid intermediate portions between the first and second openings, may provide a simpler and/or more cost-efficient construction, as the openings add cost and complexity to the side walls. Hence, while increasing the number of openings may conceivably further improve the flow properties, they will also increase production cost. By having the first opening and second opening positioned as described above in each side wall, with solid intermediate portions, provides a construction advantageously balancing improved flow properties and cost-efficiency.

In an alternative embodiment, further openings are arranged in the intermediate portions. The first opening, second opening and possible further openings in the intermediate portion may be distributed substantially equidistantly across a height of the respective walls.

In some embodiments, at least one of the openings in the respective side walls extends across the central horizontal plane CP of the drying chamber. This provides a centrally placed opening in the drying chamber, which may also improve flow properties. The centrally placed opening may be placed in between the first and second openings, if these are provided. In some embodiments, all openings in the side walls are such centrally placed openings, i.e. the portions of the first and second side wall above and beyond of the centrally placed opening, are solid.

In some embodiments, the openings in the first and second walls respectively, are arranged symmetrically about the central horizontal plane CP of the drying chamber. Having the openings arranged symmetrically in the drying chamber may improve flow properties and may improve distribution of vapor inflow to the condenser thus improving loading on the condenser and uniformity of ice build-up. Additionally, or alternatively, the openings may be arranged symmetrically about the central horizontal heating arrangement plane. Using the central horizontal heating arrangement plane as the reference plane for symmetrical placement of the openings may be advantageous in case the heating arrangement, and thus the trolley and trays, are offset from the central horizontal plane of the drying chamber.

In some embodiments, the openings of each side wall are arranged symmetrically about a central horizontal plane of the associated condenser. The central horizontal plane of the associated condenser is positioned centrally in relation to a height of the respective condenser.

In some embodiments, the first and second openings in each side wall are arranged symmetrically about the central horizontal plane of the drying chamber, and/or about the central heating horizontal arrangement plane, and/or about the central horizontal plane of the associated condenser.

In some embodiments, the openings are provided in sets of openings and each set of openings comprises at least two openings arranged sequentially along the longitudinal axis. As previously described, the openings are typically arranged along substantially the entire length of drying the chamber. However, having long openings is associated with equally long sealing elements for closing the opening for de-icing, which long sealing elements may be prone to being warped, and thus require more reinforcement. Having sets of sequential openings, may thus offer a more robust and/or simpler construction.

The specific opening embodiments described herein may all be provided as sets of openings, i.e. longitudinal sequences of openings. Hence, a set of first openings may be provided along with a set of second openings in each of the side walls. Correspondingly, a set of centrally placed openings may also be considered. As used herein, a set of openings is two or more openings arranged sequentially along the longitudinal axis and having the same height position. The set of openings could also be denoted as a row of openings. Conversely, openings having the same longitudinal positions, but different height positions, can be denoted a column of openings. The first and second opening in a side wall may thus be considered a column of openings.

The openings in a set of openings may allow fluid communication between the drying chamber and different condensing chambers, if two or more condenser chambers are arranged along the longitudinal axis, or between the drying chamber and a condenser chamber.

In some embodiments, a vacuum outlet is provided in each of the first and second condenser chambers, which vacuum outlets are arranged distally to the first and second wall, respectively, as seen in the lateral direction W. The distal position of the outlet may also improve flow properties in the condenser chamber, improving distribution of vapor and contact between vapor and condenser. The vacuum outlet is connected to one or more vacuum pumps for evacuating the drying chamber.

The respective condenser chambers may have a condenser chamber width WC from the respective side walls to an opposite wall of the respective condenser chambers, as measured along the lateral axis W. The condenser chamber width may be measured centrally in relation to a height of the respective side walls. The distally positioned vacuum outlet may be positioned at a distance equal to at least 50% of the condenser chamber width WC from the respective side walls, such as at least 60%, 70%, 80% or even 90%, said distance being measured to an outlet opening, e.g., in a vacuum manifold.

The vacuum outlets may be positioned substantially centrally with respect to a height of the first and second condensers respectively and/or in relation to a height of the first and second condenser chambers respectively.

In some embodiments, the first and second condensers comprise a plurality of tube portions extending in parallel, wherein tube portions at the vacuum outlet are more closely spaced with respect to each other than tube portions which are distal in relation the vacuum outlet. In this way the tubes adjacent to the vacuum outlet may function as a filter with improved mass transfer which captures residual condensable vapor, if any, at the outlet. The inventors have found that having closer spacing of the tube portions at the outlet improves the amount of condensable vapor captured, while only negligibly increasing flow resistance.

Said tube portions at the vacuum outlet, which are more closely spaced, may refer to the first 1, 2, 3, 4 or 5 layers of tube portions as counted from the vacuum outlet in a direction which is normal to a vacuum outlet opening. The spacing between tubes refers to the interstitial distances between tube portions. The closer spacing may be in one or two dimensions, for example the tube portions can be more closely spaced in terms of the height axis and/or the lateral axis.

The term “tube portions extending in parallel” may refer to the tubes in a shell-and-tube type condenser. The tubes in a shell-and-tube type condenser are typically bend on themselves whereby one tube may form multiple parallel tube portions.

In some embodiments, at least one guide fin element extends from the vacuum outlet in a direction towards the side wall. Multiple guide fin elements may be provided at each vacuum outlet spaced apart so as to form an entrance channel of the vacuum outlet. A guide fin element may be provided at a top of the vacuum outlet and another a guide fin element may be provided at a bottom of the vacuum outlet, so as to form an entrance channel in between the guide fins. The guide fin elements may extend at angle to the horizontal plane. The guide fin elements may extend into an interior of the condenser, for example in between the parallel tube portions of a shell-and-tube type condenser. By having such guide fin elements vapor flow is guided into the interior of the condenser, preventing vapor from bypassing the condenser and thus improving contact between vapor and condenser.

If the outlet is arranged proximally to the side wall, the guide fin elements may extend from the vacuum outlet into the condenser, away from the side wall.

The vacuum outlet is typically a manifold extending along the longitudinal axis with a plurality of outlet openings arranged along the manifold. The guide fin elements may be arranged above and below the outlet openings and extend along the longitudinal directions. The outlet openings may face toward the respective condensers, e.g., in a direction parallel with the lateral axis.

In a further development, at least some of the tube-portions which are arranged between the guide fin elements of the vacuum outlet, are more closely spaced than the distally placed tube portions.

The arrangement of the vacuum outlet as described above, may be considered a further aspect of the invention, independent of the arrangement of the openings in the side walls. Hence, also disclosed herein is a freeze-drying apparatus according to the introduction, wherein the vacuum outlets are as described above.

In some embodiments, wherein at least one of the first and second condenser comprise a plurality of tube portions each having a diameter and extending in parallel with one another, the plurality of tube portions are arranged such that, when seen in a cross-sectional plane extending perpendicularly to the longitudinal axis of the drying chamber, the plurality of tube portions form a plurality of mutually spaced apart straight columns extending in parallel with the height axis of the drying chamber, and wherein the straight columns are spaced apart with a lateral distance which is at least equal to the diameter of the tube portions. The lateral distance is measured along the lateral axis from the surfaces of tube portions of one straight column to the surfaces of the tube portions of a neighboring straight column. The lateral distance may be 1 to 5 times the diameter of the tube portions, such as 1 to 3 times, 1.5 to 3 times, or 1.5 to 2.5 times the diameter of the tube portions. Previously it has been considered advantageous to arrange the tube-portions in a staggered manner, forcing vapor to follow a winding (zig-zag-like) path in between the tube portions, but it has been found that having straight columns of tube portions space apart to provide an open flow channel in between improves vapor flow in the condenser, improves vapor capture and/or reduces pressure drop at the condenser.

The tube portions may further be arranged to form a plurality of mutually spaced apart straight rows extending in parallel with the lateral axis of the drying chamber, which straight rows are spaced apart with a height distance which is at least equal to the half the diameter of tube portions. The height distance may be less than the lateral distance and may be 0.5 to 3 times the diameter of the tube portions, such 0.5 to 2 or 0.5 to 1.5 or 0.8 to 1.2 the tube diameter.

The condenser chamber may further comprise guide fin elements, other than the guide fin elements associated with the vacuum outlet, arranged above and/or below the condenser in extension of the respective straight columns of the condenser. In this way the guide fin elements guide vapor into the channel formed between the straight columns. Such guide fin elements may comprise a curved portion thereof, angling the guide fin elements toward the respective in the openings in the respective side walls.

In some embodiments, a tubular housing of the freeze-drying apparatus defines an internal chamber and the first and second walls each extend as a chord in the internal chamber, thereby providing the drying chamber, the first condenser chamber and the second condenser chamber. This may provide both a simple construction where the tubular housing is provided and the side walls, heating arrangement, rails, and condensers are arranged therein as modules. The tubular shape is generally advantageous for pressure vessels and may also offer better flow properties compared to more angular cross-sections. The side walls extending as a chord refers to the circular cross-section of the tubular housing perpendicular to the longitudinal axis.

The side walls will typically be parallel to the height axis.

In another embodiment, a housing, such as a tubular housing, of the freeze-drying apparatus delimits the drying chamber, and the first and second condenser chambers are attached externally on the housing at either side thereof. Hence, the first and second side walls are respective portions of the housing, which portions may be curved in embodiments where the housing is tubular. Such embodiments may be referred to as having “external condensers”. The condenser chambers being attached refers to condenser housings being attached to the housing. The condenser chambers may be attached directly to the housing, i.e, there is no additional piping between drying chamber and condenser chambers, and the housing forms a wall of the condenser chamber.

In some embodiments, the freeze-drying apparatus further comprises at least two first condenser chambers at the first side of the drying chamber arranged sequentially along the longitudinal axis, and at least two second condenser chambers at the second side of the drying chamber arranged sequentially along the longitudinal axis. Having the total condenser surface area divided in this way, e.g., in four condenser chambers, allows for de-icing for example one condenser at a time, and thus for having 75% of the total condenser surface in operation for drying product. The feasibility of this is dependent on the duration of the de-icing process, which is affected by the pressure in the condenser chamber during de-icing, and the uniformity of the ice-layer distribution on the condenser surface area. The improved flow properties of the invention, leading to more uniform flow in the condenser chamber, and thus more uniform ice-layers, may make contribution to making it feasible to de-ice one condenser out of four at a time.

In a further aspect of the invention there is provided a method of operating a freeze-drying apparatus as disclosed herein, which freeze-drying apparatus has at least two first condenser chambers arranged sequentially along the longitudinal axis and at least two second condenser chambers arranged sequentially along the longitudinal axis, which method comprises the steps of
having three of the condenser chambers in an open position in fluid communication with the drying chamber,
having a further of the condenser chambers in a closed position without fluid communication with the drying chamber, and
de-icing the further condenser chamber while condensing/depositing vapor on said three condensers.

The method may further comprise sequentially closing one condenser chamber at a time for de-icing while the others are condensing vapor.

In some embodiments of the freeze-drying apparatus, each of the openings have associated valves, each valve being movable between an open position and a closed position sealing the drying chamber from the associated condenser chamber. The valves allow the condenser chambers to be sealed for de-icing.

In some embodiments, each valve comprises a sealing element movable between the open and closed position, wherein the sealing element is configured to move from the side wall into the respective condenser chambers when moving from the closed to the open position. Having the sealing element move into the condenser chamber when in the open position means that, when closed for de-icing, the pressure differential between drying chamber and condenser chamber, will contribute to maintaining the seal, as the pressure is greatest in the condenser chamber. This may allow for an increased pressure in the condenser chamber and thus reduced de-icing time, and/or simpler construction of the valve as it does not have withstand a counter-acting pressure differential.

In a further development, the valves are configured such that a proximal part of the respective sealing elements in relation to the respective condensers moves further along the lateral axis W than a distal end of the respective sealing elements does, upon moving from the closed to the open position of the valves. This is preferable for openings which arranged above and below the condensers as the sealing element will guide vapor flow to the condenser. This may also reduce pressure drop.

In some embodiments, wherein the first and second opening extend respectively above and below the respective condensers, each sealing element of the valves is connected to a valve actuator by a valve member, wherein the valve actuator is positioned outside of the condenser chamber, wherein the valve member has an extended position in which the valve is in the closed position and a retracted position in which the valve is in the open position, which valve member is accommodated in a pressure-tight housing extendable between the extended and retracted position. In this way, the valve actuator can be positioned outside of the condenser chamber, even outside of the tubular housing, where it is more accessible for e.g. maintenance or replacement while also reducing the amount of components housed inside the condenser chamber which may be detrimental to the flow properties in the condenser chamber and/or allow for more condenser surface in the condenser chamber, or to reduce the condenser chamber size and increase drying chamber size to allow for more product. The pressure-tight housing may be attached to an end portion of the valve member and to an interior condenser chamber wall, wherein the end portion of the valve member is movable between the extended and retracted position. The pressure-tight housing may be a concertinaed (bellows-like) housing. The valve actuator is understood to be the driving means, e.g., motor, which moves the valve member and in turn the sealing element. The valve actuator may be positioned outside of a tubular housing of the freeze-drying apparatus. The valve member extends within the associated condenser chamber.

In some embodiments, the at least one opening in the first and second side wall is a laterally extending opening facing down in relation the height axis.

In the freeze-drying apparatus, a height of the drying chamber extends along the height axis between the bottom and the top of the drying chamber and each of the at least one opening in each of the first and second side wall have an opening height along the height axis H. The opening height of an opening may be evaluated as the height of a projection of the opening onto the height axis.

In some embodiments, a cross-section of the freeze-drying apparatus, which cross-section is perpendicular to the to the longitudinal axis, the sum of opening heights in the first side wall or in the second side wall is equal to at least 10% of the height of drying chamber, preferably at least 15%, 20%, 25%, 30%, 35% or 40% of the height of the drying chamber. Hence the sum of opening heights may be in a range of 10 to 60%, 10 to 50%, 10 to 40%, 15 to 60%, 15 to 55%, 15 to 50%, 15 to 45%, 15 to 40%, 20 to 60%, 20 to 55%, 20 to 50%, 20 to 45%, 20 to 40%, 25 to 60 %, 25 to 55%, 25 to 50%, 25 to 45%, 25 to 40%, 30 to 60%, 30 to 55%, 30 to 50%, 30 to 45% or 30 to 40%. The sum of the opening heights in a given side wall as used herein means to look at a cross-section of the freeze-drying apparatus, which cross-section is perpendicular to the longitudinal (and thus parallel with the height axis), projecting all openings of a given side wall, which openings extend in the cross-section, and summing the heights of the resulting projections of the openings. Providing such openings advantageously reduces vapor velocity at the opening. Scaling the openings to the height of the drying chamber may be useful as the drying chamber height scales with the amount or number of trays and thus product which the freeze-drying is sized to process, and thus the height of the drying chamber is related to the vapor generation rate in the drying chamber. In embodiments having a tubular housing, the height of the drying chamber corresponds to the diameter of the internal chamber.

In further embodiments or in further developments of the preceding embodiment, the opening height of at least one of the openings in the first side wall or in the second side wall is at least 5% of the height of the drying chamber, preferably at least 5%, 7.5%, 10%, 12.5%, 15%, 17.5%, 20%, 22.5%, 25%, 27.5% or at least 30% of the height of the drying chamber. Hence, such individual opening heights may be in a range of 5 to 40%, 5 to 35%, 5 to 30%, 5 to 27.5%, 5 to 25%, 5 to 22.5%, 5 to 20%, 5 to 17.5%, 5 to 15%, 7.5 to 40%, 7.5 to 35%, 7.5 to 30%, 7.5 to 27.5%, 7.5 to 25%, 7.5 to 22.5%, 7.5 to 20%, 7.5 to 17.5%, 7.5 to 15%, 10 to 40%, 10 to 35%, 10 to 30%, 10 to 27.5%, 10 to 25%, 10 to 22.5%, 10 to 20%, 10 to 17.5%, 10 to 15%, 12.5 to 40%, 12.5 to 35%, 12.5 to 30%, 12.5 to 27.5%, 12.5 to 25%, 12.5 to 22.5%, 12.5 to 20%, 12.5 to 17.5%, 15 to 40%, 15 to 35%, 15 to 30%, 15 to 27.5%, 15 to 25%, 15 to 22.5%, 17.5 to 40%, 17.5 to 35%, 17.5 to 30%, 17.5 to 27.5%, 17.5 to 25%, 17.5 to 22.5%, 20 to 40%, 20 to 35%, 20 to 30%, 25 to 40%, or 25 to 35% of the height of the drying chamber. Having such large individual openings may provide a large sum of openings heights in a given side wall in a cost-efficient manner, with few openings. For example, an embodiment having first and second openings each with an opening height in the range of 10 to 30% of the drying chamber height provides a total opening height in the side wall of 20 to 60% of the drying chamber height.

In some embodiments, the height of the at least one opening in each of the respective side walls which extends within the stack height HS, equals at least a spacing between adjacent heating elements, preferably at least 2 or 3 times the spacing between adjacent heating elements. The height of the opening may be in the order of 1 to 10 times the spacing between adjacent heating elements, such as, 1 to 8, 2 to 8, 1 to 6, 2 to 6, 2 to 5, 3 to 5, 2 to 4, or 3 to 4 times the spacing between adjacent heating elements. The spacing between the heating elements is in this con-text measured along the height axis. The heating arrangement comprises a plurality of heating elements, which heating elements are configured to provide heat to the product to be dried. Heat may be transferred by conduction, in case of direct contact between heating element and tray (or support element of the trolley), and/or by heat radiation. The heating elements may be in the form of heating plates. The heating arrangement may be arranged such that the heating elements overlap with the trays carrying product, i.e., the trays are positioned in between two heating elements. The bottom heating element may be the heating element most proximal to the bottom of the drying chamber, and the top heating element is the heating element most proximal to the top of the drying chamber.

The first side wall and second side wall extend along the longitudinal axis. The first side wall and second side wall may extend substantially from the first end to the second end of the drying chamber, for example if only one condenser is provided in each side of the freeze-drying apparatus. Alternatively, two or more first side walls and two or more second side walls may be provided sequentially along the longitudinal axis, for example if multiple condenser chambers are provided in each side of the freeze-drying apparatus. Walls separating two condenser chamber which are both positioned in the same side of the freeze-drying apparatus are not considered side walls in the context of the invention but are denoted intermediate walls. These intermediate walls extend in a direction along the lateral axis.

In a preferred embodiment, the first and second side walls each have one or more first openings extending above the central horizontal plane of the drying chamber and at least partly within the stack height and one or more second openings extending below the central horizontal plane of the drying chamber and at least partly within the stack height, the first and second openings being arranged symmetrically about the central horizontal plane with solid intermediate portions extending between the first and second openings, wherein the first and second openings extend at least partly, preferably fully, above and below the associated condensers respectively.

In a further aspect of the invention there is provided a method for operating the freeze-drying apparatus disclosed herein, which method comprises,
i. arranging a plurality of trays carrying product in the drying chamber,
ii. opening the openings in the first and second side walls,
iii. condensing vapor on the first and second condenser,
iv. closing the openings in one of the first side wall or second side wall for de-icing the associated condenser,
v. opening the openings in one of the first side wall or second side wall after de-icing, and
vi. repeating steps iv. and v. until the product is dry.

Also disclosed herein is a freeze-drying apparatus according to the introduction, wherein a first of the openings in the respective side walls extends above the central horizontal plane of the drying chamber, and a second of the openings in the respective side walls extends below the central horizontal plane. Although presently it is presently considered advantageous for the first and second openings to extend within the stack height, it is conceivable for a freeze-drying apparatus having first and second openings extending outside of the stack height. Such first and second openings may otherwise have the features described herein, such as the symmetrical arrangement, the dimensions and/or the positions above and below the condensers as disclosed herein.

Further embodiments and details of the invention will be apparent from the following detailed description of the invention.

### BRIEF DESCRIPTION OF THE DRAWINGS

In the following, embodiments of the invention will be described with reference to the schematic drawings in which

FIG. 1 shows a cross-sectional view of a freeze-drying apparatus according to the invention as seen at a first end thereof,

FIG. 2 shows a perspective view of an embodiment of the freeze-drying apparatus,

FIG. 3a-b show details of a vacuum outlet in a condenser chamber,

FIG. 4a-e show different configurations of openings in the second side wall,

FIG. 5 shows the results of CFD simulations of the configurations of FIG. 4a-e compared to a prior art configuration,

FIG. 6 shows the relative drying chamber pressures in the CFD Simulation of FIG. 5,

FIG. 7a-b shows the ice-growth rate on the condenser in an embodiment of the invention compared to a prior art configuration obtained by CFD simulation,

FIG. 8 shows further CFD simulations of embodiments of the invention,

FIGS. 9a-b , 10, 11a-b and 12 show details of embodiments of valves arranged in the openings, and

FIG. 13 shows a CFD simulation a further embodiment where one condenser chamber is closed.

### DETAILED DESCRIPTION

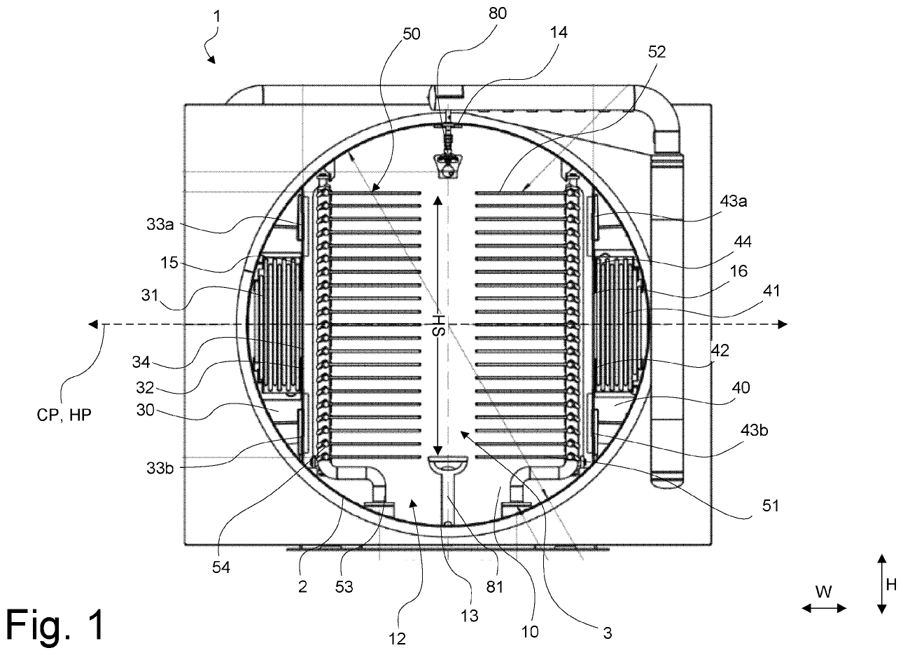

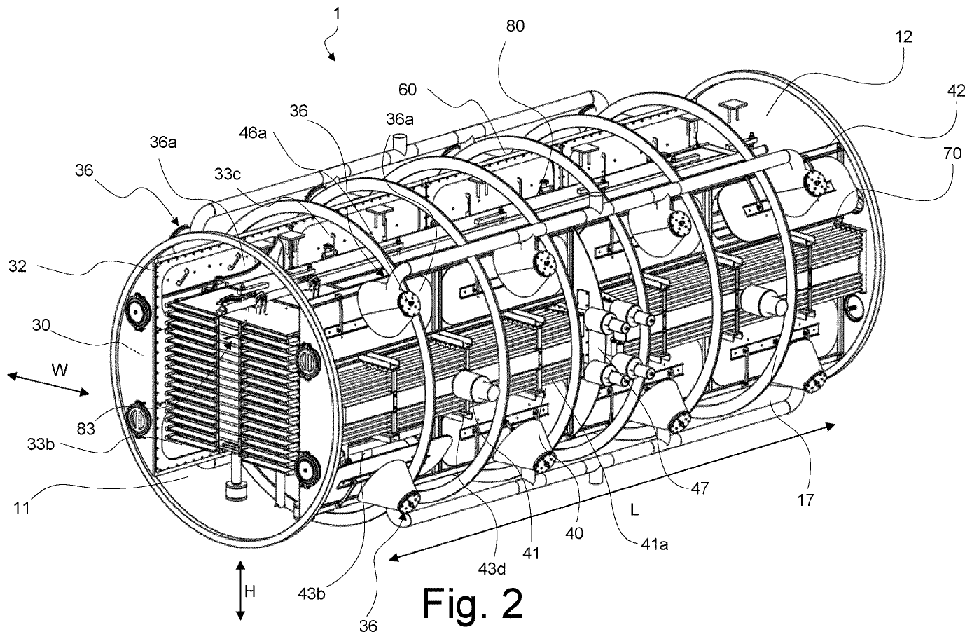

FIG. 1 shows a freeze-drying apparatus 1 as seen along a longitudinal axis L (cf. FIG. 2) from a first end (not visible) of a drying chamber 10 toward a second end 12 of the drying chamber 10. The freeze-drying apparatus has a door (not shown) at the first end and is closed at the second end 12. Hence, product to be dried moves or is moved in and out of the drying chamber at the first end. The freeze-drying apparatus 1 has a tubular housing 2 which defines an internal chamber 3 which is a cylindrical space extending from the first end to the second 12. A first side wall 32 and a second side wall 42 each extend as a chord in the tubular housing 2, thereby dividing the internal chamber 3 into the drying chamber 10, a first condenser chamber 30 and a second condenser chamber 40. The first side wall 32 and first condenser chamber 30 is arranged at a first side 15 of the drying chamber, which in FIG. 1 is the left side, and the second side wall 42 and second condenser chamber are arranged at a second side 16 of the drying chamber, which in FIG. 1 is the right side. Having the condenser chambers 30, 40 positioned laterally to the drying chamber 10 in this way has the advantage that product to be dried cannot fall from the trays (not shown) into the condenser chambers 30, 40, where it would be more difficult to clean up, than it is in the drying chamber 10.

The drying chamber 10 extends from the first side 15 to the second side 16 along a lateral axis W and from a bottom 13 of the drying chamber 10 to a top 14 of the drying chamber 10 along a height axis H. The longitudinal axis (shown on FIG. 2), lateral axis W and height axis H, are mutually perpendicular. A central horizontal plane CP of the drying chamber extends along the lateral W and longitudinal L axes at a height position halfway between in the top 14 and bottom 13 of the drying chamber 10, i.e., centrally in the drying chamber in relation to the height axis.

A heating arrangement 50 having a plurality of heating elements 51, 52 is arranged in the drying chamber 10. In this embodiment the heating elements are heating plates that extend horizontally in the drying chamber 10 and are spaced apart along the height axis H. The heating elements 51, 52 form two stacks of heating elements. The two stacks of heating elements 51, 52 are arranged at the first side 15 and second side 16 of the drying chamber 10, respectively. In the operational condition, trays carrying product to be dried are positioned in between the heating elements 51, 52 and the heating elements 51, 52 supply heat to the product to drive drying process. In each stack of heating elements 51, 52, a top heating element 52 is positioned proximal to the top 14 of the drying chamber and a bottom heating element 51 is positioned proximal to the bottom side 13 of the drying chamber. A stack height HS of the heating arrangement 50 extends between the top heating element 52 and the bottom heating element 51. The stack height HS is seen to substantially correspond to a height extent to which the stack of trays (not shown) will extend when the freeze-dryer is in the operational condition. The central horizontal plane CP of the drying chamber coincides with a central horizontal heating arrangement plane HP in this embodiment, which is positioned centrally in relation to the stack height HS. In this embodiment, the heating arrangement 50 is heated by a hot fluid, such as steam, circulated through pipe 53 and distributed by a manifold 54 to each heating element 51, 52.

A rail arrangement is provided in the drying chamber, comprising a rail 80 at the top 14 of the drying chamber and a trolley support 81 at the bottom 13 of the drying chamber. The rail arrangement is configured to receive a trolley (not shown) carrying the trays (not shown) which carry the product to be dried.

A first condenser 31 is arranged in the first condenser chamber 30 and a second condenser 41 is arranged in the second condenser chamber 40. As can be seen the first and second condenser chambers 30, 40 are symmetrically arranged at either side of the drying chamber 10. The first and second condenser 31, 41 are in this embodiment shell-and-tube type condensers, where U-shaped end-portions of the tubes are visible in FIG. 1. Fluid communication between the drying chamber 10 and the condenser chambers 30, 40 is established by openings 33a, 33b in the first side wall 32 and openings 43a, 43b in the second side wall 42. The openings 33a, 43a are positioned above the respective condenser 31, 41, and the openings 33b, 43b are positioned below the respective condenser 31, 41, distributing incoming vapor across the condensers from above and below. Each of the openings 33a-b , 43a-b in the embodiment is positioned within the stack height HS. The opening 33a in the first side wall 31 and the opening 43a in the second side wall 41 each extend above the central horizontal plane CP and above the central horizontal heating arrangement plane HP and are thus considered “first openings” according to the invention. Similarly, the opening 33b in the first side wall 31 and the opening 43b in the second side wall 41 each extend below the central horizontal plane CP and below the central horizontal heating arrangement plane HP and are thus considered “second openings” according to the invention. As can be seen, the first opening 33a and second opening 33b in first side wall 31 are arranged symmetrically about the central horizontal plane CP of the drying chamber and central horizontal heating arrangement plane HP. In this embodiment, the central horizontal plane CP of the drying chamber coincides with the central horizontal heating arrangement plane HP and a central condenser plane, and the first and second openings are thus also symmetrical about these planes. Arranging the openings symmetrically about the heating arrangement and/or the condenser may improve vapor flow distribution in the drying and/or condenser chambers.

Intermediate portions 34, 44 of the side walls 31, 41 extend between the respective first and second openings. The intermediate portions 34, 44 are in this embodiment solid.

Turning now to FIG. 2 which shows an embodiment of the freeze-drying apparatus 1 in a perspective view. The tubular housing is not shown in order to show details of the drying chamber 10 and condenser chambers 30, 40. The freeze-drying apparatus 1 has reinforcing elements 17 arranged spaced apart along the longitudinal axis L from the first end 11 to the second end 12 of the drying chamber, to which reinforcing elements 17 the housing is attached. The freeze-drying apparatus 1 shown in FIG. 2 has four condenser chambers 30, 40, 60, 70: two at the first side 15 of the drying chamber and two at the second side 16. The two condenser chambers 30, 60 at the first side 15 are arranged sequentially along the longitudinal axis Land are both denoted as “first condenser chambers” 30, 60. Similarly, the two condenser chambers 40, 70 at the second side 16 are arranged sequentially along the longitudinal axis L and are both denoted as “second condenser chambers”. The two second condenser chambers 40, 70 are not in fluid communication as they are separated by intermediate wall 47. The same applies to the two first condenser chambers 30, 60 although the corresponding intermediate wall is not visible in FIG. 2. As can be seen the two first condenser chambers 30, 60 are identical but for their longitudinal positions, as are the two second condenser chambers 40, 70. The condenser 41 is a shell-and-tube-type condenser having a plurality of parallel tube portions 41a on which vapor condensates/deposits during drying. Each condenser chamber 30, 40, 60, 70 have four openings: two above the condensers and above the central horizontal plane of the drying chamber (first openings) and two below the condenser and below the central horizontal plane of the drying chamber (second openings). In the first condenser chamber 30, the two first openings are indicated by reference numerals 33a and 33c and in the second condenser chamber 40 the two second openings are indicated by reference numerals 43b and 43d. Hence, in this embodiment each condenser chamber has a set of first openings and set of second openings, the openings in each set being arranged sequentially along the longitudinal axis L. All of the openings have the same rectangular shape with rounded corners and have the same dimensions. As in FIG. 1, the openings are positioned within the stack height, symmetrically about the central horizontal heating arrangement plane (not shown) and the central horizontal plane of the drying chamber (not shown), which may be difficult to discern due to the perspective view in FIG. 2.

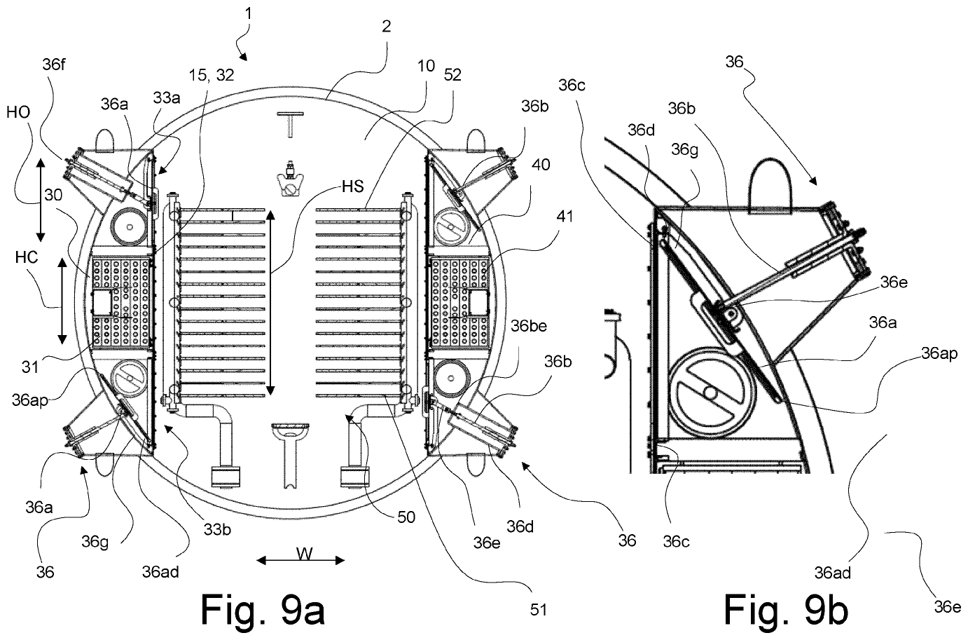

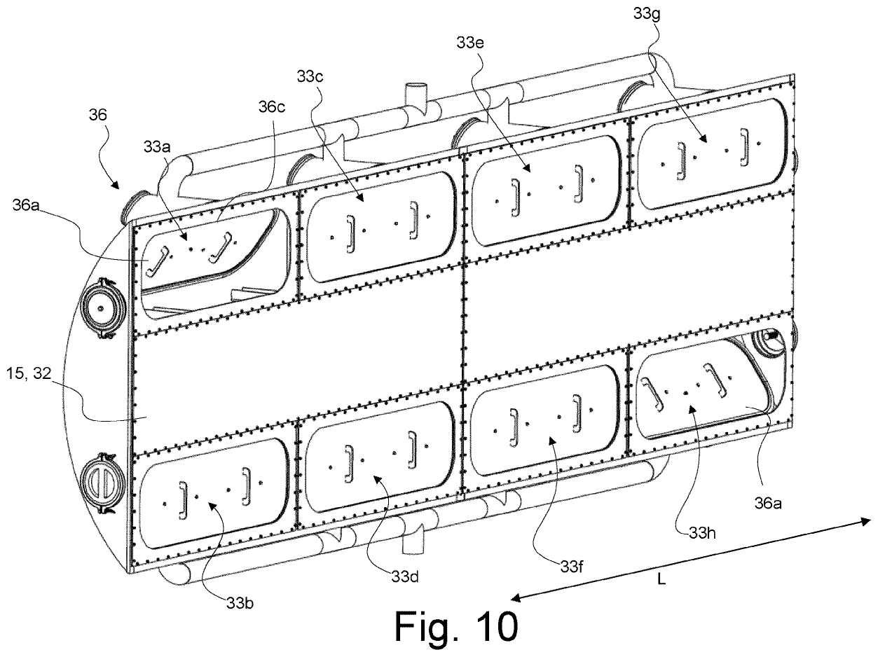

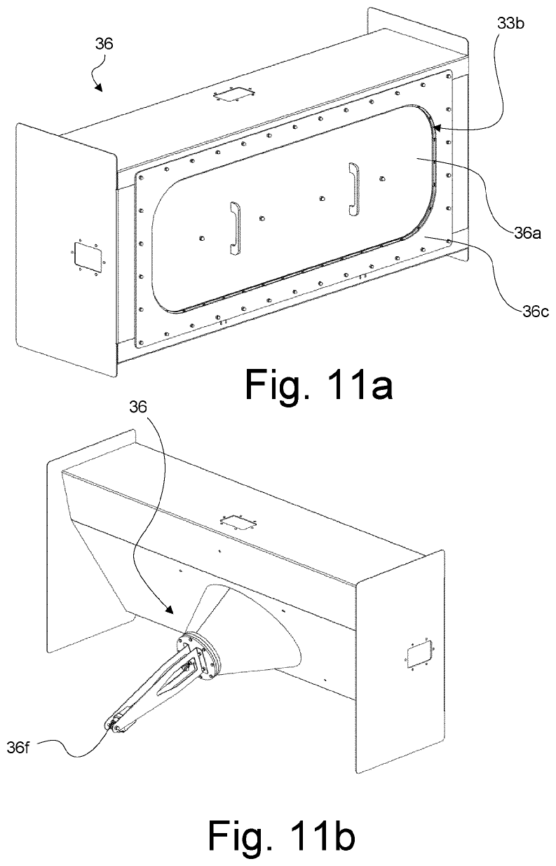

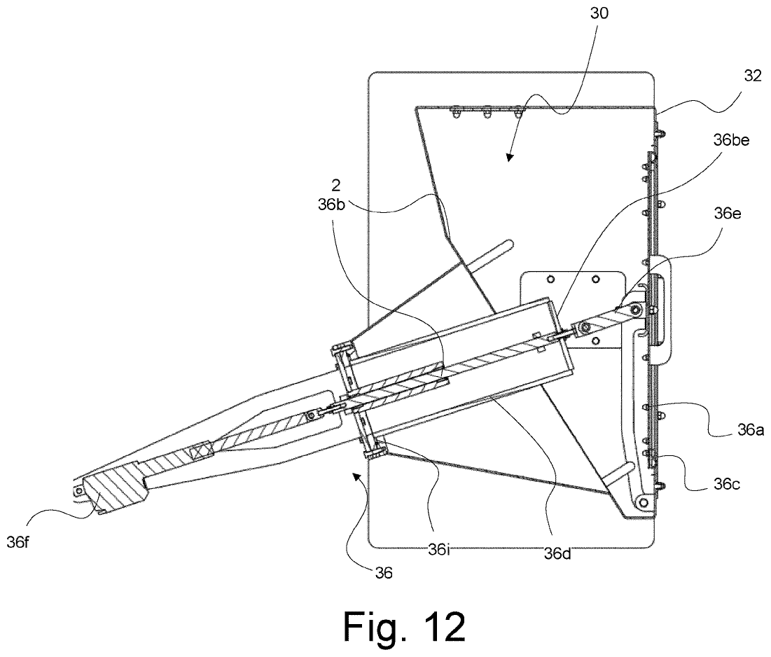

Still referring to FIG. 2, each opening is provided with a valve 36 having a sealing element 36a. The sealing element 36a is configured to close the associated opening and is thus in this embodiment a rectangular plate. If for example the set of first openings 33a, 33c were instead provided as one opening, a corresponding sealing element would be twice as long the sealing elements in FIG. 2. Each valve also has a valve actuator (not shown, see FIGS. 11-12) mounted on the exterior side of the tubular housing (not shown), which actuator is configured to move the sealing element 36a between a closed position, shown for example at the openings 33c and 43d, where it seals the drying chamber 10 from the condenser chamber 40 to an open position, shown at opening 33a and 43b where vapor can flow between drying chamber 10 and condenser chambers 30, 40. Further details of valves which can be used in freeze-drying apparatus 1 are shown in FIGS. 9 and 11 and will be described in detail further below.

In FIG. 2 a trolley 83 is in the process of being positioned in the drying chamber 10, moving from the first end 11 to the second end 12 of the drying chamber along rail 80.

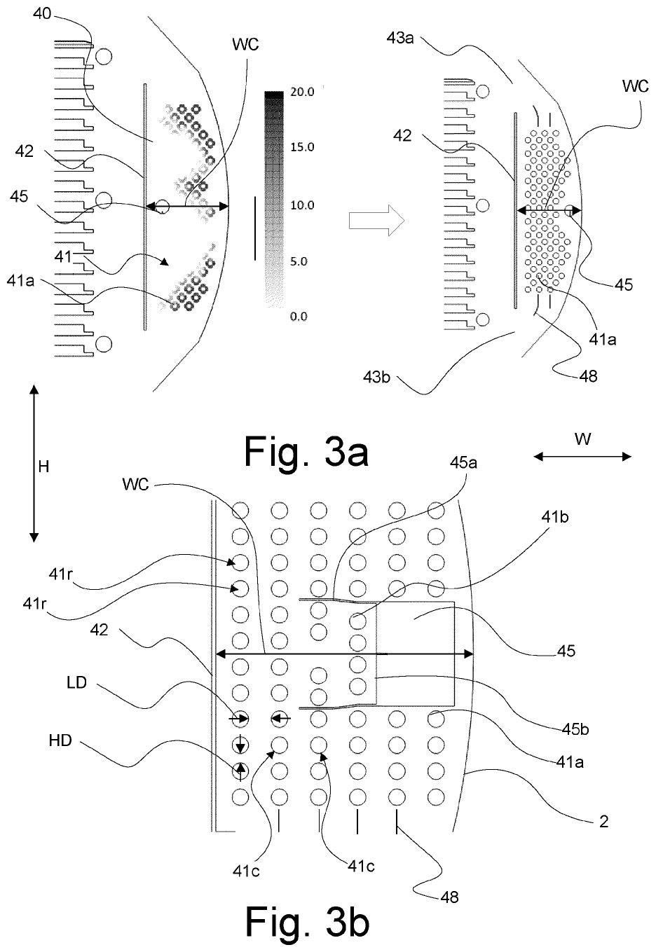

Turning now to FIGS. 3a-b which show further details of the condenser chambers. FIGS. 3a-b show a cross-sectional view of condenser chamber 40 with second condenser 41 having parallel tube portions 41a and second side wall 42, but the details shown may apply to all condenser chambers. The left-hand side of FIG. 3a shows simulated ice-growth rates (mm/time unit) on the condenser tubes 41a, of which some of the condenser tubes 41a are not visible, due to low ice-growth rates which are shown in white. On the left-hand side of FIG. 3a a vacuum outlet 45 is arranged centrally in the condenser chamber 40 with respect to the height axis H, and proximal to the second side wall 42, here within 30% of a width of the condenser chamber WC (measured centrally in relation to the height axis H along the lateral axis) from the second side wall 42. While this will work, it has been found that moving the outlet 45 to a distal position in relation to the second sidewall 42 as shown in the right-hand side of FIG. 3a, improves the flow properties of the condenser chamber 40 potentially increasing contact between vapor and condenser, whereby the vapor meets cold condenser surface area which may lead to increased condensation. In the right-hand side of FIG. 3a, the vacuum outlet 45 is positioned at distance from the second side wall 42 which is equal to about 55% of the lateral width of the condenser chamber WC. The vacuum outlet 45 of the right-hand side of FIG. 3a further comprises two guide fins 45a which extend in a direction toward the second side wall 42, in this case at an angle of about 30 degrees to the lateral axis W. The guide fins 45a guide vapor into an interior of the condenser 41 before entering between the guide fins 45a which are seen to form an entrance to channel leading to a vacuum outlet opening (not shown) which faces the second side wall 42. In FIG. 3a the vacuum outlet 45 is a tubular manifold with outlet openings (not visible) facing in a direction parallel with the lateral axis W, which in the left-hand embodiment is towards the right and in the right-hand embodiment is towards the left.

A further embodiment of the vacuum outlet 45 is show in FIG. 3b, where the outlet 45 is positioned at a distance equal to about 60% of the width of the condenser chamber WC from the second side wall 42. In this embodiment the vacuum outlet 45 has a rectangular cross-section with a plurality of openings 45b spaced apart along the longitudinal axis L. The position of the vacuum outlet 45 is evaluated at the vacuum outlet opening 45b which here faces the second side wall 42 and is positioned in the entrance channel defined by the guide fins 45a. As can be seen the first layer of tube portions 41b as counted from the outlet opening 45b is more closely spaced than the tube portions which are distal in relation to the vacuum outlet 45, e.g., the tube portions proximal to the second side wall 42. In this way the tube portions act as a filter for any residual condensable gas immediately before the outlet opening. In this embodiment the tube portions are more closely spaced along the height axis H, but it is also conceivable that multiple layers of tube portions could more closely spaced along the lateral axis W. The spacing in the first layer of tube portions is here about ⅔ of a diameter of the tube portion whereas the spacing distally from the vacuum outlet is about equal to the tube portion diameter (in the height axis). Additional guide fins 48 (separate from those of the outlet) are provided in the second condenser chamber, to guide vapor flow to the condenser 41. In the embodiment of FIG. 3a (right hand), the guide fin elements 48 have curved portion angling the guide fin elements toward the first and second opening 43a, 43b.

In FIG. 3a the tube portions 41a are arranged in a staggered manner as seen in the cross-sectional plane perpendicular to longitudinal axis (corresponding to the view of FIG. 3a-b ) where vapor flowing downwards and upwards from the first opening 43a and second opening 43b respectively, will flow in a winding path in-between the tube portions 41a toward the vacuum outlet 45. In FIG. 3b the plurality of tube portions 41a are seen to be arranged in a plurality of straight columns 41c along the height axis H which are mutually spaced apart with a lateral distance LD in between the straight columns 41c of tube portions 41a. Hence, there is an open flow path along the height axis H. The tube portions 41a are also arranged in a plurality of straight rows 41r mutually spaced apart with a height distance HD. The lateral distance LD and height distances is measured from the surface of the tube portions of neighboring straight columns 41c or straight rows 41r respectively. In FIG. 3b the lateral distance is about 2 times the diameter of the tube portions 41 a and the height distance HD is about equal the diameter of the tube portions. The lateral distance LD and HD distances described here refer to the general spacing of the tube portions 41a in the condenser, and not to the local spacing proximal to vacuum outlet 45 which can be more closely to provide filter section as previously described. The guide fin elements 48 in the condenser chamber 40 below the condenser 41 are arranged as an extension of the straight columns 41c of tube portions 41a, whereby the guide fin elements 48 guide vapor into the open flow path between the straight columns of tube portions 41a.

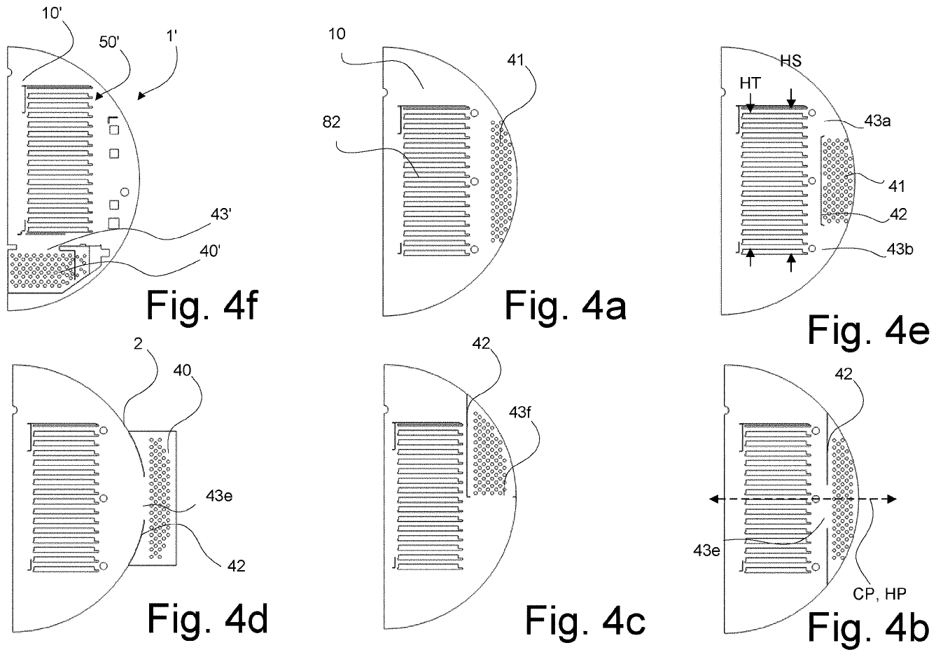

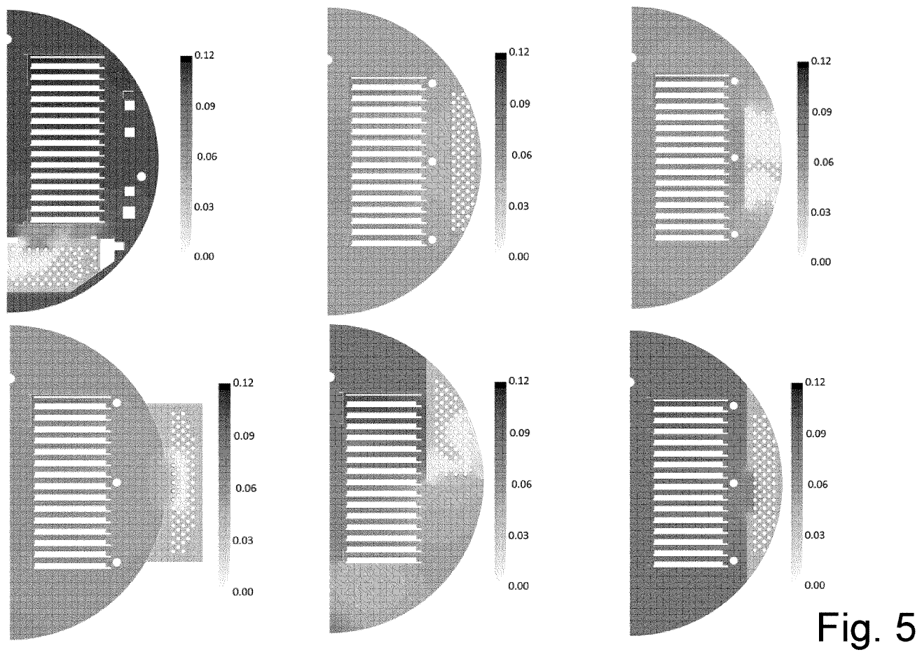

Turning now to FIG. 4a-f which show the second side of a tubular freeze-dryer 1 as seen along the longitudinal axis. FIG. 4a shows a freeze-dryer where the second condenser 41 is arranged inside the drying chamber 10 providing a direct flow path for vapor from trays 82 to the second condenser 41. Hence, FIG. 4a may serve a reference for evaluating performance of other configurations, FIG. 4a being an “ideal” case for fluid flow properties.

FIG. 4b shows a configuration with the second side wall 42 providing condenser chamber 40, wherein a centrally placed opening 43e extending across and symmetrically about the central horizontal plane CP (and central heating arrangement plane) is provided as the only opening into the condenser chamber 40 (multiple such central openings may be arranged sequentially along the longitudinal axis L). The centrally placed opening 43e extends within the rack height HS.

FIG. 4c shows a configuration wherein an opening 43f in the second side wall 42 extends laterally and the opening faces downwards in relation to the height axis H. This opening also extends within the rack height HS.

FIG. 4d shows an external condenser configuration wherein the tubular housing 2 delimits the drying chamber 10 and the condenser chamber 40 is attached to an external side of the tubular housing 2. The centrally placed opening 43e is here formed in the part of the tubular housing 2 which forms a wall 42 of the condenser chamber 40, which part is thus considered the second side wall 42.

FIG. 4e shows yet another configuration, corresponding to FIGS. 1 and 2, where the first opening 43a in the second side wall 42 extends above the central horizontal planes CP, HP and above the second condenser 41 and the second opening 43b extends below the central horizontal planes CP, HP and below the second condenser 41. For illustrative purposes the stack height HS of the heating arrangement is indicated alongside the height extent HT of the trays, where the latter is seen to be slightly shorter than the former.

FIG. 4f shows a representation of a prior art configuration whit a heating arrangement 50′ in a drying chamber 10′ of a freeze-drying apparatus 1′, wherein a condenser chamber 40′ having an opening 43′, is positioned below the heating arrangement 50′ with respect to the heating arrangement 50′ with respect to the height axis.

In FIGS. 4b, 4d, 4e a height of each opening is, by way of example, equal to about 17% of the height of the drying chamber, which is here the diameter of the tubular housing 2.

Turning now to FIG. 5 which show computational fluid dynamics (CFD) simulations of the configurations shown in FIG. 4a-e and a configuration similar to the applicant's prior art system in operation. FIG. 5 illustrates the pressure profile in the freeze-drying apparatus 1,. The unit scales of each configuration is the same, thus allowing comparison of the results. The simulations reflect the same operating conditions, e.g. vapor generation rate, same inflow rate of non-condensable gas, and same condenser temperature each case. Generally, the simulations shown herein are not necessarily optimized configurations or optimized with respect to operating conditions. Simulations have been performed using the applicant's proprietary software.

Referring initially to the top left configuration in FIG. 5 which is a representation of the applicant's prior art system having the condenser chamber positioned below the heating arrangement stack and the trays. The pressure field in the drying chamber is seen to be relatively uniform at a pressure level of about 0.1 mbar with slightly higher pressures within the stack of trays, whereas in the region immediately below the trays above the condenser chamber the pressure is at about 0.05 mbar and in the condenser chamber it is in the range of about 0.00 to 0.02 mbar. It is desirable to reduce pressure drop from drying chamber to condenser chamber.

Turning to the simulation of the top-center configuration of FIG. 5 which is the “ideal” configuration shown in FIG. 4a which may serve as a reference for performance. As can be seen, the pressure is substantially uniform in the drying chamber at about 0.06 mbar and in the region of the condenser about 0.03 mbar. Hence, the “ideal” configuration provides a lower pressure in the drying chamber compared to the prior art. The pressure in the condenser region is also higher than in the prior art and close the pressure of the drying chamber and more uniform, signifying an improved distribution of vapor across the condenser and a lower pressure drop from drying chamber to condenser region. While the ideal configuration improves flow properties, it does not allow for sealing the condenser from the drying chamber for de-icing.

Turning now to the embodiment on the top-right of FIG. 5 denoted “Top/down gate” which has the first opening and the second opening in the second side wall. The pressure profile of FIG. 5 shows that the pressure in the drying chamber is comparable to the ideal configuration, at about 0.06 mbar, improving on the prior art configuration.

Turning now to the embodiment on the bottom-left of FIG. 5 denoted “Outside gate” having a centrally positioned opening within the stack height leading to the condenser chamber attached to the tubular housing. The pressure in the drying chamber is seen to be at about 0.06 mbar with a condenser chamber pressure at the opening at about 0.00 mbar and 0.03 mbar distal from the opening.

Turning now to the embodiment on the bottom-center of FIG. 5 denoted “Downwards gate” having a centrally placed opening extending laterally facing downwards. Comparing the pressure profile to the prior art solution, the average drying chamber pressure is reduced, but the pressure is less uniform in the drying chamber compared to the ideal solution.

Turning now to the bottom-right configuration of FIG. 5 denoted “Sideways gate” having a centrally positioned opening in the second side wall which extends as chord in the tubular housing. The configuration shows a reduced and more uniform drying chamber pressure of less than 0.09 mbar, compared to the prior art solution. Similarly, the condenser chamber pressure is at about 0.04 mbar and substantially uniform.

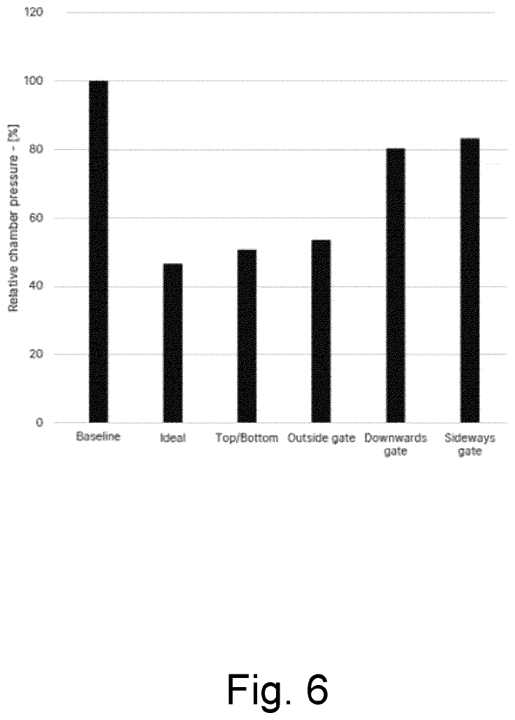

Hence each of the embodiments in FIG. 4b-e improve the fluid flow properties of the freeze-drying apparatus. This also reflected in FIG. 6 showing the relative drying chamber pressures of each of the six configurations of FIG. 5 evaluated at the same position in each of the six simulations. The prior art solution (Baseline) is the reference, having a relative chamber pressure of 100%, the ideal solution at about 47% (Ideal), the configuration with first and second openings at about 50% (Top/Bottom), the external condenser chamber configuration at about 54% (Out-side gate), the downwards facing opening at about 80% (Downwards gate) and the centrally placed opening at about 82% (Sideways gate).

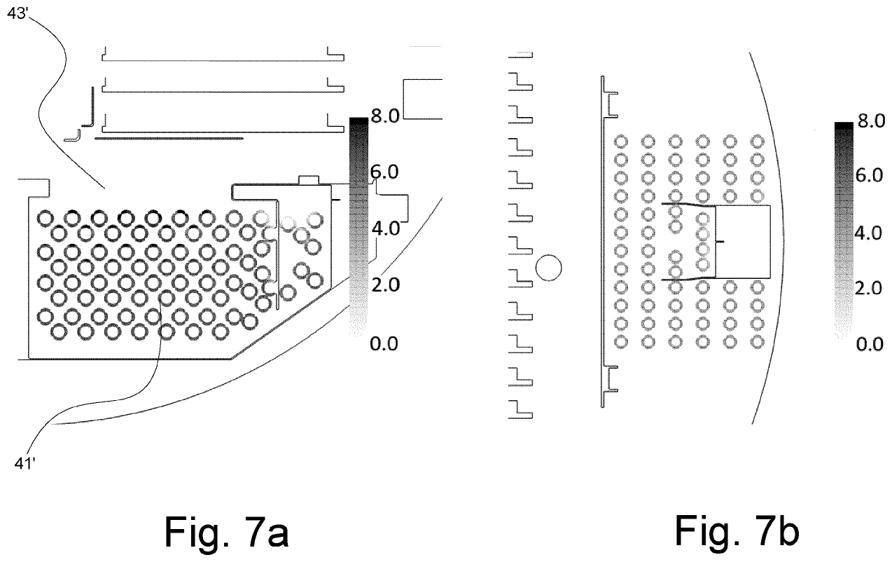

Referring now to FIGS. 7a-b which show the ice-growth rates (mm/time unit) on the condenser surface in CFD simulations of a prior art configuration (FIG. 7a), which is similar to FIG. 4f, and an embodiment of the invention (FIG. 7a) which is similar to the embodiment in FIG. 4e, i.e., a “top-down” embodiment. As can be seen the ice growth rate in the prior art configuration is highest (darker shading) at the opening 43′, leading to thick ice-layers which may increase pressure drop, and the ice-growth rate could be more uniform across the condenser 41′. In the right-hand embodiment, the ice-growth rate is lower and more uniform across the condenser signifying better flow properties.

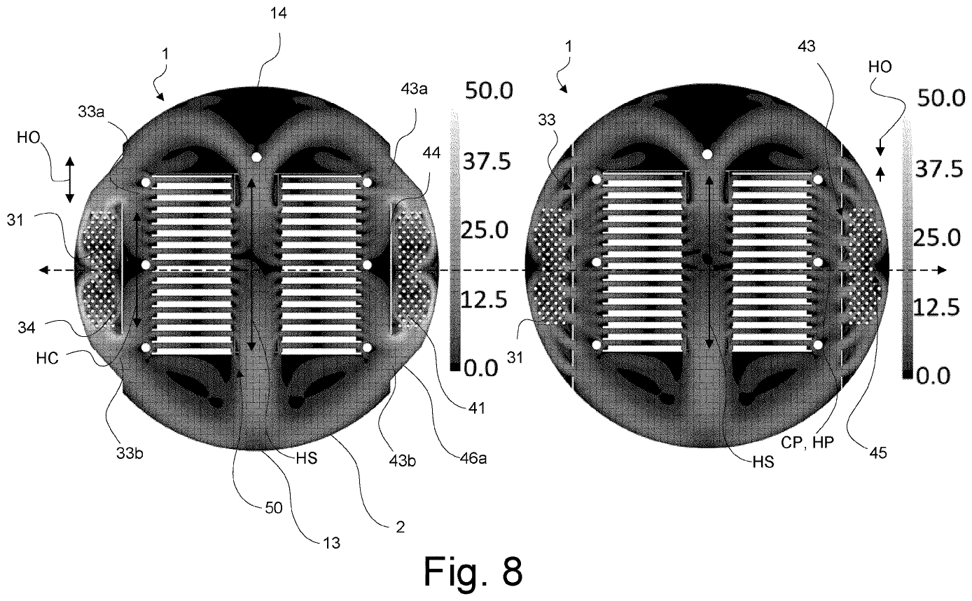

Referring now to FIG. 8 which shows CFD simulated velocity profiles of two embodiments of the freeze-drying apparatus 1. In the left-hand configuration the first and second side walls 31 and 41 have respective first openings 33a, 43a extending partly within the stack height HS, partly above the stack height HS and above the central horizontal plane CP of the drying chamber, which is seen to substantially coincide with central horizontal plane of the condensers and of the central horizontal heating arrangement plane HP. The first openings 33a, 43a also extend fully above the respective condensers 30, 40 as there is no overlap between an opening height HO and a condenser height HC. Each opening height HO is in this embodiment equal to about 4 times a distance between two adjacent heating elements and equal to about 13% of the height of the drying chamber, which is measured between bottom 13 and top 14 of the drying chamber along the height axis. Corresponding respective second openings 33b, 43b are provided in the first side wall 31 and the second side wall 41. Hence, in a cross-section of the freeze-drying apparatus, which cross-section is perpendicular to the longitudinal axis, (i.e. the cross-sections shown in FIG. 8), the sum of opening heights (HO) in each of the first side wall 32 second side wall 42 is about 26% of the height of the drying chamber. The intermediate portions 34, 44 in each side wall 31, 41 is seen to be solid in the left-hand embodiment. It is noted that that the angular portions of the tubular housing 2 at the openings correspond to the sealing element 46 of the valve (not shown) which opens and closes the respective openings. The right-hand embodiment corresponds to the left-hand except that nine openings 33, 43 are provided in each side wall, each having an opening height HO which is equal to about the distance between adjacent heating elements and equal to about 2.9% of the height of the drying chamber. In the cross-section of the freeze-drying apparatus which is perpendicular to the longitudinal direction, there will be nine openings in each side wall which thus have a total opening height of about 26% of the drying chamber height. One of the openings extends across the central horizontal plane CP and an additional four openings are provided symmetrically above and below the central horizonal plane CP, of which four openings three are provided within the stack height HS. The position of the vacuum outlet 45 is indicated at the second condenser 40 and has corresponding positions in the first condenser chamber in both embodiments shown in FIG. 8. By comparing the velocity profiles of the two embodiments it is seen that the right-hand embodiment with nine openings provide a slightly more uniform velocity field in the condenser chambers than the left-hand embodiment, but the right-hand embodiment is a simpler construction which is both more cost-efficient and has fewer moving components, thus reducing the risk of errors. The embodiments shown in FIG. 8 are exemplary and it conceivable that a taller heating arrangement 50 can be used, increasing the number of trays in the freeze-drying apparatus 1, such as is shown in FIG. 1.

Referring now to FIGS. 9a-b showing cross-sectional views of an embodiment of the freeze-drying apparatus 1 and details of the valves 36. The first condenser chamber 30 comprises first and second openings 33a, 33b in the first side wall 32 extending partly within the stack height HS of the heating arrangement 50 and above and below the first condenser 31 respectively. The opening height HO of each opening is about nine times the spacing between adjacent heating elements 51 and about 22% of the height of the drying chamber 10 (which is the same as the diameter of the internal chamber defined by the tubular housing 2.

The bottom left and top-right valves 36 in an open position allowing fluid communication between drying chamber 10 and first condenser chamber 30 and second condenser chamber 40 respectively, and the top-left and bottom-right valves are in a closed position. The sealing elements 36a move into the condenser chamber 30 when moving from the closed position to the open position (FIG. 9b). The valves 36 are hinged such that a proximal part 36ap of the sealing elements 36a move further in the lateral direction W than a distal part 36ad of the sealing elements 36a,which proximal part 36ap is the part of the sealing element 36a which proximal in relation the associated condenser 31, 41 and which distal part 36ad is distal in relation to the respective condenser 31, 41. In this way, the sealing elements 36a assume a position wherein they will guide the vapor toward the condenser 31. The valve actuator (position indicated at 36f, but not shown, see FIG. 12) is positioned outside of the condenser chambers 30, 40 and outside of the tubular housing 2. A valve member 36b is connected to the sealing element 36a by way of hinge 36e and to the valve actuator (not shown). When the valve is open, the valve member 36b is in a extended position as shown in FIG. 9b and when the valve is closed, the valve member 36b is in an extended position shown at the top-right valve of FIG. 9a. The valve member 36b is housed in a pressure/vacuum-tight housing 36d, where is here shown in a schematic manner, but may be a concertinaed (bellows-like) housing capable of extending and collapsing between the closed position and the open position of the valve 36. The housing 36d is attached to an internal surface of the condenser chamber 30 at one end and to an end portion 36be of the valve member at the other end, which is shown in greater detail in FIG. 12. The end portion 36be is here a plate connected to the sealing element 36a by way of the hinge 36e. A valve seat 36c is provided on the first side wall 32 against which the sealing elements 36a abuts in the closed position. The sealing elements 36a are further supported by hinged arms 36g attached to the side walls. During de-icing the valve 36 is in the closed position and the pressure differential between drying chamber 10 and condenser chamber 30 contributes to keeping the valve 36 closed. In FIG. 9a, the top-left and bottom-right valves are the same type having the pressure tight housing 36d,which is different from the bottom-left and top-right valves which is an alternative embodiment, where the valve member 36b extend and move through a pressure-tight hollow cylinder. This is for illustrative purposes. In practice, the valves will typically be of the same type.

Referring now to FIG. 10 which shows a perspective view of the of the first side 15 of the freeze-drying apparatus. A set of first openings 33a, 33c, 33e, 33 is positioned sequentially along the longitudinal axis L and a set of second openings 33b, 33d, 33e positioned sequentially along the longitudinal axis.

Referring now to FIGS. 11a-b which show a further embodiment of the valve 36 for an opening (indicated as the second opening 33b in FIG. 11a). The valve 36 is shown as a mock-up isolated from the freeze-drying apparatus (not shown) and hence the cabinet shown is not a condenser chamber. FIG. 11a is a perspective view showing the valve 36 with the valve actuator (motor) 36f external to the cabinet (which would be the condenser chamber when installed in the freeze-drying apparatus (not shown)) and with the sealing element in the process of being opened. FIG. 11b shows the valve 36b from another point of view.

Referring now to FIG. 12 showing a cross-section of an embodiment of the valve 36, showing the valve actuator 36f outside of the condenser chamber 30. The valve actuator 36f is connected to hinge 36e by way of valve member 36b which extends within the condenser chamber 30 inside a pressure-tight housing 36d which can extend and retract. The pressure-tight housing 36d is here shown in a schematic manner. The valve member 36b and pressure-tight housing 36d extend within a frustrum-like shaped extension of the housing 2. The housing 2 and the frustrum-shaped extension forms an interior surface of the condenser chamber 30. The pressure-tight housing 36d is attached to the end portion 36be of the valve member 36e and the interior surface 36i thereby forming a spacing which accommodates the valve member 36e and which is sealed from the condenser chamber 30.

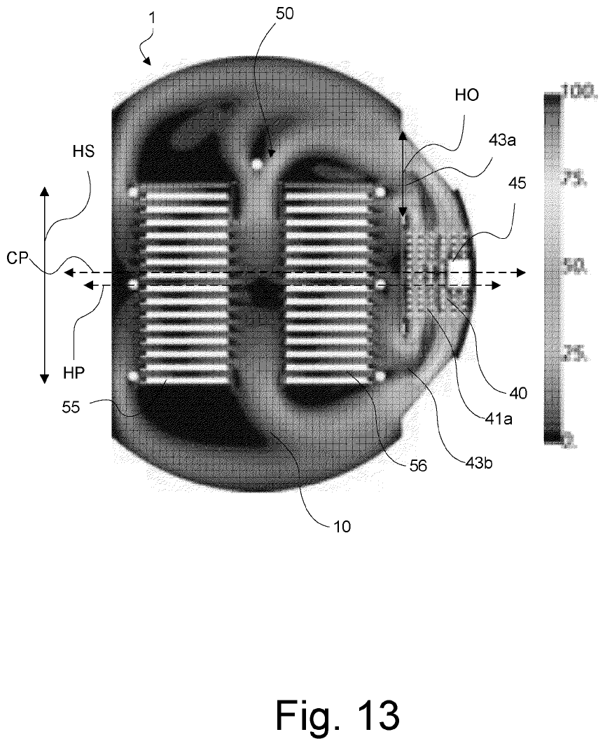

Referring now to FIG. 13 which shows the simulated velocity profile of a further embodiment having the first opening 43a and second opening 43b extending partly within the stack height HS. In this simulation the first condenser chamber (not shown) is closed for de-icing and the second condenser chamber 40 is in operation. In this embodiment the rack arrangement 50 has two stacks 55, 56 of heating elements which are offset from the drying chamber in the sense that central heating arrangement plane HP is offset from the central horizontal plane CP of the drying chamber 10. The first and second openings 43a-b are arranged symmetrically about the central horizontal plane CP and each have opening heights HO which are about 7 times the distance between adjacent heating elements in the stacks 55, 56, which is equal to about 20% of the height of the drying chamber. Hence, in a cross-section of the freeze-drying apparatus which is perpendicular to the longitudinal axis, the sum of the opening heights HO in each side wall is about 40% of the height of the drying chamber. The tube portions 41a of the condenser is seen to be arranged in straight columns and straight rows in a manner similar to that of FIG. 3b. As can be seen, when condenser chambers are positioned laterally to the heating arrangement, and one condenser chamber is closed for de-icing, the vapor from the stack 55 will flow substantially into the flow pattern from the other stack 56 proximal to the open condenser chamber, here the second condenser chamber 40, rather than distorting the existing vapor flow as may be the case in other configurations, such as the one in the top-left of FIG. 5.

What is claimed is:

1. A freeze-drying apparatus comprising:
a drying chamber extending from a first end to a second end of the drying chamber along a longitudinal axis, from a bottom to a top of the drying chamber along a height axis, and from a first side to a second side of the drying chamber along a lateral axis, a central horizontal plane of the drying chamber extending in parallel to the longitudinal and lateral axes and being positioned centrally in the drying chamber in relation to the height axis,
a door at the first end of the drying chamber,
a first condenser chamber comprising a first condenser arranged laterally to the drying chamber at the first side with a first wall between the first condenser chamber and the drying chamber,
a second condenser chamber comprising a second condenser arranged laterally to the drying chamber at the second side with a second wall between the second condenser chamber and the drying chamber,
each of which first and second walls is provided with at least one opening allowing fluid communication between the drying chamber and the respective condenser chamber, and
a heating arrangement comprising a plurality of heating elements, which heating elements are spaced apart in the height axis, with a stack height extending between a bottom heating element and a top heating element,
wherein at least one of the openings in each of the first and second wall extends at least partially within the stack height, and
wherein a first of the openings in the respective side walls extends above the central horizontal plane of the drying chamber, and a second of the openings in the respective side walls extends below the central horizontal plane, and
wherein each of the openings have associated valves, each valve being moveable between an open position and a closed position sealing the drying chamber from the associated condenser chamber, and
wherein respective intermediate portions of the first and second walls extending between the respective first and second openings are solid meaning that no openings between the condenser chamber and drying chamber are provided in the intermediate portions.

2. A freeze-drying apparatus according to claim 1, wherein the first opening is provided at least partly above the respective condensers and the second opening is provided at least partly below the respective condensers.

3. A freeze-drying apparatus according to claim 1, wherein one or more of the first or second opening extend at least partially within the stack height.

4. (canceled)

5. A freeze-drying apparatus according to claim 1, wherein the openings in the first and second walls respectively, are arranged one or both of symmetrically about the central horizontal plane of the drying chamber, or symmetrically about a central horizontal heating arrangement plane which extends in parallel to the longitudinal and lateral axes and centrally in relation to the stack height.

6. A freeze-drying apparatus according to claim 1, wherein the openings are provided in sets of openings and each set of openings comprises at least two openings arranged sequentially along the longitudinal axis.

7. A freeze-drying apparatus according to claim 1, wherein a height of the drying chamber extends along the height axis between the bottom and the top of the drying chamber, wherein each of the at least one opening in each of the first and second side wall has an opening height along the height axis,
and in a cross-section of the freeze-drying apparatus perpendicular to the longitudinal axis, the sum of opening heights in the first side wall or in the second side wall is equal to at least 10% of the height of drying chamber.

8. A freeze-drying apparatus according to claim 7, wherein the opening height of at least one of the opening(s) in the first side wall or in the second side wall is at least 5% of the height of the drying chamber.

9. A freeze-drying apparatus according to claim 1, wherein a vacuum outlet is provided in each of the first and second condenser chambers, which vacuum outlets are arranged distally to the first and second wall respectively as seen in the lateral direction.

10. A freeze-drying apparatus according to claim 9, wherein the first and second condenser comprise a plurality of tube portions extending in parallel, wherein the tube portions at the vacuum outlet are more closely spaced with respect to each other than the tube portions which are distal in relation the vacuum outlet.

11. A freeze-drying apparatus according to claim 10, further comprising at least one guide fin element extending from the vacuum outlet in a direction towards the side wall.

12. A freeze-drying apparatus according to claim 1, wherein a tubular housing of the freeze-drying apparatus defines an internal chamber and the first and second walls each extend as a chord in the internal chamber, thereby providing the drying chamber, the first condenser chamber, and the second condenser chamber.

13. A freeze-drying apparatus according to claim 1, comprising at least two first condenser chambers at the first side of the drying chamber arranged sequentially along the longitudinal axis, and at least two second condenser chambers at the second side of the drying chamber arranged sequentially along the longitudinal axis.

14. (canceled)

15. A freeze-drying apparatus according to claim 1, wherein each valve comprises a sealing element movable between the open and closed position, wherein the sealing element is configured to move from the side wall into the respective condenser chambers when moving from the closed to the open position.

16. A freeze-drying apparatus according to claim 1, wherein at least one of the first and second condenser comprises a plurality of tube portions each having a diameter and extending in parallel with one another, wherein the plurality of tube portions are arranged such that, when seen in a cross-sectional plane extending perpendicularly to the longitudinal axis of the drying chamber, the plurality of tube portions form a plurality of mutually spaced apart straight columns extending in parallel with the height axis of the drying chamber, and wherein the straight columns are spaced apart with a lateral distance which is at least equal to the diameter of the tube portions.

17. A freeze-drying apparatus according to claim 7, wherein in the cross-section of the freeze-drying apparatus perpendicular to the to the longitudinal axis, the sum of opening heights in the first side wall or in the second side wall is equal to at least 20% or 30% of the height of the drying chamber.

18. A freeze-drying apparatus according to claim 7, wherein the opening height of the at least one of the opening(s) in the first side wall or in the second side wall is at least 7.5%, 10%, 12.5%, 15% or 17.5% of the height of the drying chamber.

19. A freeze-drying apparatus according to claim 15, wherein the valves are configured such that a proximal part of the respective sealing elements in relation the respective condensers moves further along the lateral axis than a distal end of the respective sealing elements does, upon moving from the closed to the open position of the valves.
